(19) United States
(12) Patent Application Publication
(10) Pub. No.: US 2011/0042599 A1
(43) Pub. Date: Feb. 24, 2011

(54) FLUID CONTROL VALVE

(75) Inventors: Masato Arai, Nagoya-city (JP); Osamu Shimane, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/858,654

(22) Filed: Aug. 18, 2010

(30) Foreign Application Priority Data
Aug. 21, 2009 (JP) 2009-192317

(51) Int. Cl. F16K 31/44

(52) U.S. Cl. 251/251

(57) ABSTRACT

A fluid control valve includes a housing having a seat ring and a plate spring, a butterfly valve, and a valve shaft. The valve shaft has a plane-surface portion and a cam portion, which are arranged adjacent to each other. The fluid control valve is configured such that when an opening degree of the butterfly valve is a first valve opening degree or more, the cam portion is brought into sliding contact with the seat ring and the seat ring is pushed to a location radially outward of a moving path of the butterfly valve against elastic force of the plate spring. Thus, occurrence of uneven wear on a seat surface of the seat ring can be suppressed.

### CROSS REFERENCE TO RELATED APPLICATION

The present application is based on Japanese Patent Application No. 2009-192317 filed on Aug. 21, 2009, the disclosure of which is incorporated herein by reference.

### FIELD OF THE INVENTION

The present invention relates to a fluid control valve, in which a rotational axis line (i.e., a rotational axis) of a shaft is decentered from a center position of a valve (i.e., a valve center, a sealing position with a seat ring), specifically, relates to an exhaust-gas control valve that controls exhaust gas flowing out of an internal combustion engine.

### BACKGROUND OF THE INVENTION

Conventionally, as shown in FIGS. 6 to 8, an air-intake control valve, in which a rotational axis line (i.e., a rotational axis) of a shaft 101 is decentered by a predetermined distance in an axial line direction from a center position of a butterfly valve 102 (i.e., a valve center, a sealing position with a seat ring 106), has been proposed (refer to JP-A-2005-344803, for example).

The valve 102 has an outer peripheral sealing surface (i.e., a contact surface) 103 whose outer peripheral surface configures a part of a sphere.

The air-intake control valve is configured such that when the valve 2 is in a fully-closed state, the contact surface 103 of the valve 102 is firmly attached to a valve seat portion (i.e., a valve seat surface) 107 of the circular ring-shaped seat ring 106, which is elastically supported by an engine main body 104 and a housing 105.

As shown in FIG. 8, a distance between a cylinder portion (i.e., a cylinder portion having therein an intake port) 111 of the engine main body 104 and an inner projection 112 of the housing 105 is slightly larger than a thickness of the seat ring 106. Thus, the seat ring 106 is elastically supported so as to be capable of moving in the axial line direction, which is perpendicular to a rotational axis line direction of the shaft 101. An O-ring 114 made of rubber is arranged in a circular groove 113 formed in the cylinder portion 111 of the engine main body 104 in a compression state. The seat ring 106 is biased toward the inner projection 112 of the housing 105 by biasing force of the O-ring 114.

Furthermore, as shown in FIG. 8, an inner diameter of an inner recess 115 of the housing 105 is slightly larger than an outer diameter of the seat ring 106. Thus, the seat ring 106 is elastically supported so as to be capable of moving in a radial direction thereof. A holding ring 109 made of resin is arranged in a circular groove 116 formed on an outer peripheral surface of the seat ring 106, and the seat ring 106 slidably contacts the inner recess 115 of the housing 105 through the holding ring 109.

However, in the air-intake control valve described in JP-A-2005-344803, the valve 102 and the seat surface 107 of the seat ring 106 always slide each other in a valve-rotation range of the valve 102 from a fully-closed position to a fully-opened position via an intermediate position. As the shaft 101 rotates from the fully-closed position to the fully-opened position, a contact area of a sliding part between the valve 102 and the seat ring 106 is changed to be decreased. Thus, uneven wear (i.e., out-of-roundness) occurs on the seat surface 107 of the seat ring 106, and thereby intake air may leak from a gap formed by the uneven wear on the seat surface 107 (i.e., a gap formed between the seat surface 107 and the contact surface 103 of the valve 102) when the valve 2 is in the fully-closed state. That is, the amount of leaking intake air when the valve 2 is in the fully-closed state may be increased due to the uneven wear which occurs on the seat ring 106.

As shown in FIGS. 9 to 11, in the case where the air-intake control valve described in JP-A-2005-344803 is applied to an EGR control valve that controls the flow amount of high-temperature exhaust gas (i.e., EGR gas), the shaft 1, the valve 102, and the seat ring 106 are made of heat resisting metal materials such as stainless steel.

In the case of the EGR control valve, by rotating the shaft 101, the sliding part between the valve 102 and the seat ring 106 is changed.

As shown in FIG. 9, when the valve 2 is in the fully-closed state, the contact surface 103 of the valve 102 and the seat surface 107 of the seat ring 106 are firmly sealed, that is, the entire circumference of the valve 102 is sealed, and the contact area between the contact surface 103 and the seat surface 107 becomes the largest.

As shown in FIG. 10, when the valve 102 rotates from a fully-closed opening degree to an intermediate opening degree, the contact area of a sliding part 121 between the valve 102 and the seat ring 106 (i.e., a sliding part between a valve and a seat ring without two-step motion) becomes smaller than that when the valve 2 is in the fully-closed state.

As shown in FIG. 11, when the valve 102 rotates from the intermediate opening degree to a fully-opened opening degree, the contact area of a sliding part 122 between the valve 102 and the seat ring 106 (i.e., a sliding part between a valve and a seat ring without two-step motion) becomes smaller than that when the valve 102 is in a state of the intermediate opening degree shown in FIG. 10.

Therefore, in the EGR control valve, the valve 102 and the seat surface 107 of the seat ring 106 always slide each other in the range from the fully-closed opening degree to the fully-opened opening degree. Since the contact area of the sliding part between the valve 102 and the seat ring 106 becomes small as the shaft 101 rotates, the amount of the uneven wear becomes large on the sliding parts 121, 122 between the valve 102 and the seat ring 106, specifically, on the sliding part 122.

Thus, the EGR gas leaks from the gap formed by the uneven wear on the seat surface 107 of the seat ring 106 when the valve 2 is in the fully-closed state, and thereby, sealing performance when the valve 2 is in the fully-closed state may be decreased.

### SUMMARY OF THE INVENTION

It is an object of the present invention to provide a fluid control valve which can limit increasing of the amount of leaking fluid and decreasing of sealing performance when a valve is in a fully-closed state by suppressing occurrence of uneven wear on a sealing portion of a seat ring.

According to one aspect of the present invention, a fluid control valve includes: a housing defining therein a fluid passage and having a seat ring and an elastic member; a valve housed in the housing, the valve being configured to open and close the fluid passage; and a shaft to which the valve is fixed, rotatably supported in the housing, the shaft having a cam portion. A rotational axis line of the shaft is decentered from a center position of the valve. The seat ring is configured to move in a flow direction of a fluid flowing through the fluid passage and the elastic member elastically holds the seat ring. The seat ring has a sealing portion to which the valve is firmly attached when the valve fully closes the fluid passage. The cam portion is configured to be brought into sliding contact with the seat ring and push the seat ring to a location radially outward of a moving path of a large-diameter side edge surface of the valve against elastic force of the elastic member when the valve opens the fluid passage at a predetermined opening degree or more.

Accordingly, when the valve opens the fluid passage at the predetermined opening degree or more in accordance with rotating of the shaft, the cam portion formed on the shaft pushes the seat ring to the location radially outward of the moving path of the valve (i.e., a rotating path of the valve with the rotational axis line of the shaft centered), that is, pushes the seat ring to be separated from the valve in the flow direction of the fluid.

Therefore, when the valve opens the fluid passage at the predetermined opening degree or more, the sealing portion of the seat ring is not brought into sliding contact with the valve. Thus, occurrence of uneven wear on the sealing portion of the seat ring can be suppressed, and thereby, increasing of the amount of leaking fluid and decreasing of sealing performance when the valve fully closes the fluid passage (also referred to as when the valve is in a fully-closed state), that is, when the valve is firmly attached to the sealing portion of the seat ring, can be limited.

It is preferable that a worn position (i.e., a sliding part) of the seat ring, which is brought into sliding contact with the cam portion of the shaft, is a position different from the sealing portion of the seat ring (for example, a side surface, i.e., an end surface at a side of the shaft, of the seat ring).

When the valve is in the fully-closed state, the sealing portion of the seat ring, which is always elastically held by the elastic member, is firmly attached to the valve. Thus, the high sealing performance can be maintained between the sealing portion of the seat ring and the valve. That is, by elastically holding the seat ring by the elastic member, the sealing performance between the sealing portion of the seat ring and the valve when the valve is in the fully-closed state can be improved.

When the valve opens the fluid passage at the predetermined opening degree or more in accordance with rotating of the shaft, the seat ring moves to be separated from the valve against the elastic force of the elastic member (that is, the seat ring is pushed to the location radially outward of the moving path of the valve by the cam portion), and thereby, the valve fixed to the shaft can rotate smoothly. Thus, sliding torque between the seat ring and the valve when the valve opens the fluid passage at the predetermined opening degree or more can be decreased.

Therefore, improving of the sealing performance between the sealing portion of the seat ring and the valve when the valve is in the fully-closed state, and decreasing of the sliding torque between the seat ring and the valve when the valve opens the fluid passage can be obtained.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross-sectional view showing an EGR gas flow-amount control valve (hereinafter referred to as EGRV) in a fully-dosed state according to a first embodiment of the present invention;

FIG. 2 is a cross-sectional view showing the EGRV in a fully-opened state according to the first embodiment of the present invention;

FIG. 3A is a cross-sectional view showing a main part of the EGRV according to the first embodiment of the present invention;

FIG. 3B is an enlarged view of FIG. 3A;

FIGS. 4A to 4C are explanation views showing movement of a seat ring by rotating a shaft in an EGR gas flow direction according to the first embodiment of the present invention;

FIG. 5 is a cross-sectional view showing a main part of an EGRV according to a second embodiment of the present invention;

FIG. 6 is an explanation view showing an air-intake control valve in a fully-closed state according to a related art;

FIG. 7 is an explanation view showing the air-intake control valve in a state of an intermediate opening degree according to the related art;

FIG. 8 is a cross-sectional view showing a main part of the air-intake control valve according to the related art;

FIG. 9 is a perspective view showing an EGR control valve in a fully-closed state according to the related art;

FIG. 10 is a perspective view showing the EGR control valve in a state of an intermediate opening degree according to the related art; and

FIG. 11 is a perspective view showing the EGR control valve in a fully-opened state according to the related art.

### DETAILED DESCRIPTION OF THE PREFERRED EMBODIMENTS

Hereinafter, embodiments of the present invention will be described with reference to drawings.

### First Embodiment

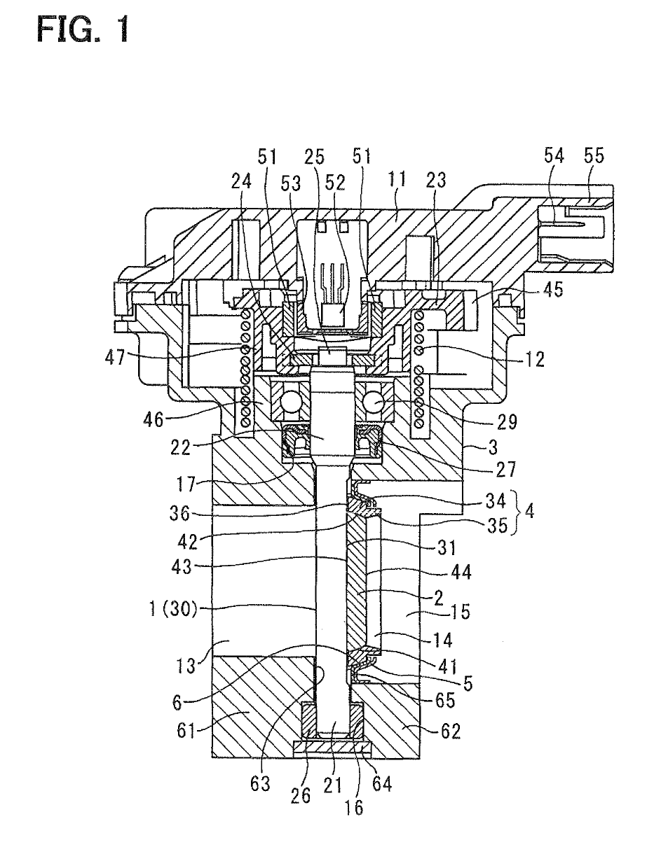

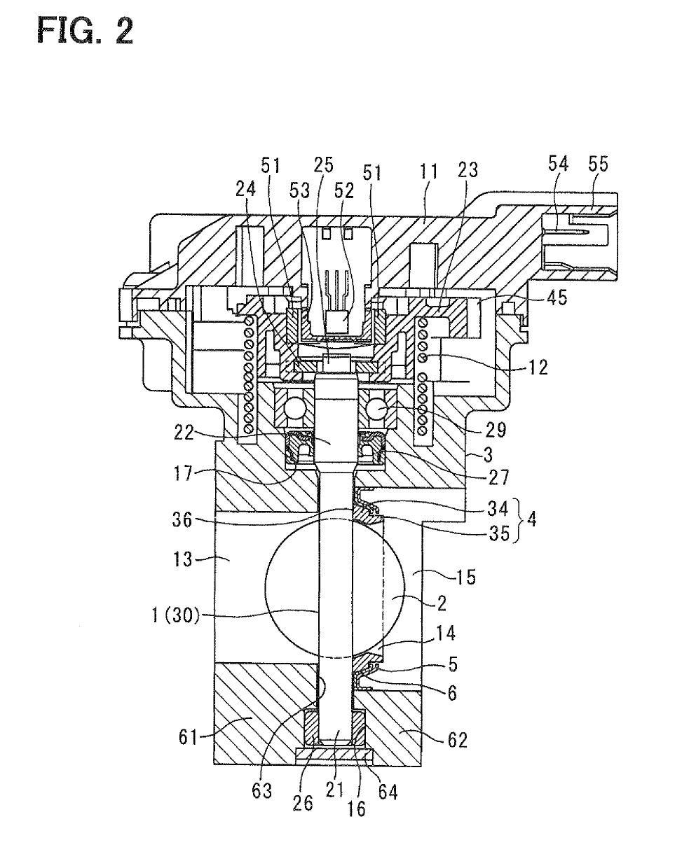

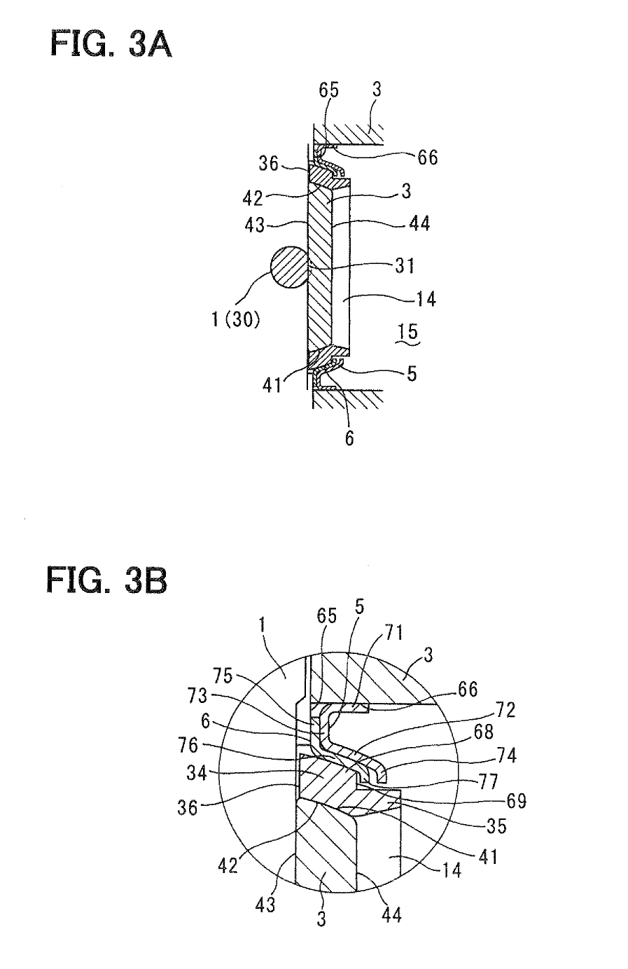

The first embodiment of the present invention is shown in FIGS. 1 to 4C. FIG. 1 is a view showing an EGR gas flow-amount control valve (hereinafter referred to as EGRV) in a fully-closed state, and FIG. 2 is a view showing the EGRV in a fully-opened state.

An exhaust-gas recirculation device of an internal combustion engine of the present embodiment is used for an internal combustion engine (i.e., an engine) such as a diesel engine. The exhaust-gas recirculation device is an EGR system (i.e., an EGR device of the internal combustion engine) that recirculates EGR gas, which is a part of exhaust gas (i.e., exhaust gas of the internal combustion engine) flowing out of a combustion chamber in each cylinder of the engine, to an intake pipe such as an intake manifold or an intake duct from an exhaust pipe such as an exhaust manifold or an exhaust duct.

The intake pipe has therein an intake passage that is communicated with the combustion chamber in each cylinder of the engine and an intake port. Furthermore, the exhaust pipe has therein an exhaust passage that is communicated with the combustion chamber in each cylinder of the engine and an exhaust port.

The EGR system is mounted to an engine compartment of a vehicle such as a car. The EGR system has an exhaust-gas recirculation pipe that recirculates the EGR gas to the intake passage formed in the intake pipe from the exhaust passage formed in the exhaust pipe.

An exhaust gas flow-amount control valve, that is, the EGR gas flow-amount control valve (i.e., the EGRV) that controls the flow amount of the exhaust gas (i.e., the EGR gas) is arranged in the exhaust-gas recirculation pipe.

The EGRV of the present embodiment is an exhaust-gas control valve (i.e., a fluid control valve), in which a rotational axis line (i.e., a rotational axis) of a valve shaft 1 is decentered to a downstream side or an upstream side of an EGR gas flow direction by a predetermined distance from a center position of a butterfly valve 2 (i.e., a valve center, a sealing position with a seat ring 4).

The EGRV includes the valve shaft (i.e., a valve axis of the EGRV) 1 that extends straightly in a rotational axis line direction, the butterfly valve (i.e., a valve body of the EGRV) 2 in which the valve center is decentered with respect to the rotational axis line of the valve shaft 1, an electric actuator that drives the butterfly valve 2 in a valve opening direction or a valve closing direction, a valve opening degree sensor that detects a rotational angle (i.e., a valve opening degree) of the butterfly valve 2, and a valve housing 3 that rotatably supports the valve shaft 1.

The valve shaft 1 is rotatably supported in the valve housing 3 of the present embodiment. The butterfly valve 2 is openably and closably (rotatably) housed in the valve housing 3. Moreover, the seat ring 4, to which the butterfly valve 2 is firmly attached when the butterfly valve 2 is in the fully-closed state, is placed inside the valve housing 3. The seat ring 4 is elastically held (i.e., floating-supported) by the valve housing 3 through a plate spring 5 made of metal and a sealing member 6 in the EGR gas flow direction or a radial direction thereof.

Moreover, a coil spring (i.e., a valve biasing means) 12 that biases the butterfly valve 2 in the valve closing direction or the valve opening direction, is placed in a space (i.e., an actuator housing) formed between the valve housing 3 made of metal and a sensor cover 11 made of synthetic resin.

Exhaust-gas recirculation passages 13 to 15, through which the EGR gas is recirculated to the intake pipe from the exhaust pipe, are formed inside the valve housing 3. The exhaust-gas recirculation passage 14 configures a part of a fluid flow passage, and is a communication passage (i.e., an opening portion) that communicates between the exhaust-gas recirculation passage 13 and the exhaust-gas recirculation passage 15. The exhaust-gas recirculation passage 14 is formed inside the seat ring 4.

In the present embodiment, the EGRV is configured such that the EGR gas flows from the exhaust-gas recirculation passage 13 to the exhaust-gas recirculation passage 15 through the exhaust-gas recirculation passage 14 in the valve housing 3. However, the EGRV may be configured such that the EGR gas flows from the exhaust-gas recirculation passage 15 to the exhaust-gas recirculation passage 13 through the exhaust-gas recirculation passage 14 in the valve housing 3.

The valve shaft 1 of the present embodiment is made of heat resisting material (for example, stainless steel or heat resisting steel), which is excellent in heat resistance, and is rotatably or slidably housed inside first and second through-holes 16, 17 formed in the valve housing 3. The valve shaft 1 is a shaft having a circular cross-section (i.e., a circular metal shaft) whose cross section perpendicular to the rotational axis line direction is formed to be a circular shape.

A first sliding portion (i.e., a small diameter portion) 21 having a circular cross section is arranged at one end portion (i.e., a lower end portion in FIGS. 1 and 2) of the valve shaft 1 in the rotational axis line direction. A second sliding portion (i.e., a large diameter portion, that is, a largest diameter portion having the largest outer diameter in the valve shaft 1) 22 having a circular cross section is arranged at the other end portion (i.e., an upper end portion in FIGS. 1 and 2) of the valve shaft 1 in the rotational axis line direction. The outer diameter of the second sliding portion 22 is larger than that of the first sliding portion 21.

A caulking fixing portion 25 is formed integrally with the second sliding portion 22 at one end side (i.e., at a side of the sensor cover 11) of the second sliding portion 22 in the rotational axis line direction. The caulking fixing portion 25 is used for fixing a valve gear plate 24 which is insert-molded in an inner peripheral portion of a final reduction gear 23 by a fixing means such as caulking. That is, the final reduction gear 23 is fixed to the valve shaft 1.

The first sliding portion 21 of the valve shaft 1 is rotatably supported by a wall surface of the first though-hole 16 of the valve housing 3 through a bushing 26. The second sliding portion 22 of the valve shaft 1 is rotatably supported by a wall surface of the second though-hole 17 of the valve housing 3 through an oil seal 27 and a ball bearing 29.

The valve shaft 1 has an axial direction portion 30, which has a cross-sectional shape of D-cut, between the first sliding portion 21 and the second sliding portion 22. The axial direction portion 30 has a plane-surface portion (i.e., an attaching portion) 31 and a cam portion (i.e., a contacting portion) 33. A part of the valve shaft 1 in a circumferential direction is cut to be a planar shape so that the plane-surface portion 31 is formed. Furthermore, another part of the valve shaft 1 in the circumferential direction is formed to have the same diameter (i.e., outer diameter) with a maximum outer-diameter portion of the axial direction portion 30 so that the cam portion 33 is formed.

The plane-surface portion 31 of the valve shaft 1 has a surface parallel to the rotational axis line direction of the valve shaft 1 at a position which is dented toward a side of the rotational axis line by a predetermined distance from the maximum outer-diameter portion of the axial direction portion 30. The plane-surface portion 31 is an opposed portion which is arranged to be opposed to the seat ring 4 with a predetermined gap therebetween in the EGR gas flow direction when the butterfly valve 2 closes the exhaust-gas recirculation passages 13 to 15 at a second valve opening degree or less.

A stepped portion formed between the plane-surface portion 31 and the cam portion 33 may be a surface perpendicular to the plane-surface portion 31 or a sloped surface (i.e., a curved surface) which smoothly connects the plane-surface portion 31 to the cam portion 33.

The cam portion 33 of the valve shaft 1 is formed on a part of the axial direction portion 30 in the circumferential direction and adjacent to the plane-surface portion 31. The cam portion 33 has a circular convex curved surface having a predetermined curvature radius (i.e., the outer diameter of the axial direction portion 30) when the rotational axis line of the valve shaft 1 is centered. A top surface of the cam portion 33 may be arranged at a position which is protruded outward from the outer diameter of the axial direction portion 30 of the valve shaft 1 in a radial direction of the axial direction portion 30. That is, the cam portion 33 may be the maximum outer-diameter portion which has an outer diameter larger than that of the axial direction portion 30.

When the butterfly valve 2 rotates to open the exhaust-gas recirculation passages 13 to 15 at a first valve opening degree or more, the cam portion 33 is brought into sliding contact with a sliding part 36 of the seat ring 4 having a thick portion 34 and a thin portion 35. The sliding part 36 is an end surface of the thick portion 34 at a side of the valve shaft 1. The EGRV is configured such that the cam portion 33 pushes the seat ring 4 to a location radially outward of a moving path (i.e., a rotating path) of the butterfly valve 2 against elastic force of the plate spring 5 (i.e., elastic force which biases a seat surface 42 of the seat ring 4 toward a contact surface 41 of the butterfly valve 2). At this time, the cam portion 33 is directly engaged with the sliding part 36.

The EGRV is configured such that when the butterfly valve 2 closes the exhaust-gas recirculation passages 13 to 15 at the second valve opening degree or less, the sliding contact between the cam portion 33 and the sliding part 36 of the seat ring 4 is released and the cam portion 33 is separated from the sliding part 36 of the seat ring 4.

For example, the cam portion 33 may be configured such that, in the case where the butterfly valve 2 is rotated in the valve opening direction from the fully-closed state to the fully-opened state, when the opening degree of the butterfly valve 2 becomes the first valve opening degree or more, the cam portion 33 of the valve shaft 1 contacts the sliding part 36 of the seat ring 4. The cam portion 33 may be configured such that, in the case where the butterfly valve 2 is rotated in the valve closing direction from the fully-opened state to the fully-closed state, when the opening degree of the butterfly valve 2 becomes the second valve opening degree or less, the cam portion 33 of the valve shaft 1 is separated from the sliding part 36 of the seat ring 4.

The first valve opening degree may be the same with or different from the second valve opening degree. Moreover, there may be hysteresis between the first valve opening degree and the second valve opening degree.

The butterfly valve 2 is made of heat resisting material (for example, stainless steel or heat resisting steel), which is excellent in heat resistance, and is formed to have a circular plate shape. The butterfly valve 2 is attached to a center portion of the plane-surface portion 31 of the valve shaft 1 (i.e., a portion arranged in the exhaust-gas recirculation passage 13, a valve attaching portion) by using a welding means such as laser welding.

The butterfly valve 2 is a rotary valve which relatively rotates with respect to the valve housing 3 and the seat ring 4 to open and close the exhaust-gas recirculation passages 13 to 15. The butterfly valve 2 is configured by a circular valve plate.

In the engine operation, the butterfly valve 2 is operated to rotate in a valve-operation range from the fully-closed position, at which the valve 2 fully closes the exhaust-gas recirculation passages 13 to 15, to the fully-opened position, at which the valve 2 fully opens the exhaust-gas recirculation passages 13 to 15, based on control signals from an engine control unit (i.e., an engine control device, hereinafter referred to as an ECU). Thus, specifically, an opening area (i.e., an exhaust-gas flowing area) of the exhaust-gas recirculation passage 14 among the exhaust-gas recirculation passages 13 to 15 is changed, and thereby the EGR amount is variably controlled.

When the butterfly valve 2 is in the fully-closed state, the butterfly valve 2 is set to be at the fully-closed position, at which the valve 2 fully closes the exhaust-gas recirculation passages 13 to 15. When the butterfly valve 2 is in the fully-opened state, the butterfly valve 2 is set to be at the fully-opened position, at which the valve 2 fully opens the exhaust-gas recirculation passages 13 to 15. Moreover, the butterfly valve 2 is set to be the intermediate opening degree between the fully-closed position and the fully-opened position in accordance with a condition of the engine operation.

As shown in FIG. 1, the fully-closed position of the butterfly valve 2 is a position where a gap between the contact surface 41 of the butterfly valve 2 and the seat surface 42 of the seat ring 4 becomes minimal, and means the fully-closed opening degree (θ=0°) which minimizes the EGR amount of the EGR gas (i.e., the amount of leaking EGR gas) flowing through the exhaust-gas recirculation passages 13 to 15.

As shown in FIG. 2, the fully-opened position of the butterfly valve 2 is a position where the gap between the contact surface 41 of the butterfly valve 2 and the seat surface 42 of the seat ring 4 becomes maximal, and means the fully-opened opening degree (θ=70° to 90°) which maximizes the EGR amount of the EGR gas flowing through the exhaust-gas recirculation passages 13 to 15.

The butterfly valve 2 has an outer peripheral surface (i.e., the contact surface, an outer peripheral sealing surface) 41 configured by a part of a sphere. When the exhaust-gas recirculation passages 13 to 15 are fully closed by the butterfly valve 2, the contact surface 41 of the butterfly valve 2 is firmly attached to the seat surface (i.e., a sealing portion) 42 of the seat ring 4. When the contact surface 41 of the butterfly valve 2 is firmly attached to the seat surface 42 of the seat ring 4, the exhaust-gas recirculation passages 13 to 15 formed inside the valve housing 3 are closed. When the contact surface 41 of the butterfly valve 2 is separated from the seat surface 42 of the seat ring 4, the exhaust-gas recirculation passages 13 to 15 are opened.

The butterfly valve 2 has a thickness thinner than a dimension of the seat ring 4 in the EGR gas flow direction.

The butterfly valve 2 has a circular large-diameter side edge surface 43 at one end surface thereof (i.e., an upstream-side end surface located at an upstream side of the EGR gas flow direction when the butterfly valve 2 is in the fully-closed state) in a thickness direction of the butterfly valve 2. The large-diameter side edge surface 43 is fixed to and supported at the plane-surface portion (i.e., a plane-surface cut portion) 31 formed on an outer peripheral portion of the valve shaft 1 by using a welding means such as laser welding. The butterfly valve 2 has a circular small-diameter side edge surface 44 at the other end surface thereof (i.e., a downstream-side end surface located at a downstream side of the EGR gas flow direction when the butterfly valve 2 is in the fully-closed state) in the thickness direction. An outer diameter of the small-diameter side edge surface 44 is smaller than that of the large-diameter side edge surface 43.

A motor for driving the butterfly valve 2 of the EGRV is electrically connected to a battery mounted to the vehicle via a motor drive circuit that is electronically controlled by the ECU.

The electric actuator of the present embodiment includes a motor that generates driving force in response to supply of electric power, a power-transmitting mechanism that transmits the driving force of the motor to the valve shaft 1, and the like.

The power-transmitting mechanism is configured by a gear reduction mechanism that reduces a rotating speed of the motor by double reduction, for example, to become a predetermined reduction ratio, and increases the driving force of the motor (i.e., motor torque) to drive the valve shaft 1. The gear reduction mechanism includes a motor gear fixed to a motor shaft (i.e., an output shaft) of the motor, an intermediate reduction gear that is engaged with the motor gear, and the final reduction gear 23 that is engaged with the intermediate reduction gear.

The final reduction gear 23 is made of synthetic resin. The valve gear plate 24 made of metal material is insert-molded in the inner peripheral portion of the final reduction gear 23. A circular outer peripheral portion is formed in a part of the final reduction gear 23 in the circumferential direction. Multiple convex gear teeth (i.e., a gear portion) 45 that are engaged with the intermediate reduction gear are formed on an outer peripheral surface of the outer peripheral portion.

A fully-closed side stopper portion is placed at one end portion of the outer peripheral portion of the final reduction gear 23 in the circumferential direction. When the butterfly valve 2 is operated to rotate in the valve closing direction beyond the fully-closed position, the fully-closed side stopper portion is mechanically engaged with a fully-closed side stopper member (i.e., a screw for adjusting a maximum fully-closed opening degree) screwed in a block-shaped fully-closed side stopper integrally formed with the valve housing 3. Thus, when the fully-closed side stopper portion of the final reduction gear 23 contacts the fully-closed side stopper or the fully-closed side stopper member, the rotating operation of a movable member (i.e., a rotatable member) such as the valve shaft 1, the butterfly valve 2 and the final reduction gear 23 in the valve closing direction is limited.

A fully-opened side stopper portion is placed at the other end portion of the outer peripheral portion of the final reduction gear 23 in the circumferential direction. When the butterfly valve 2 is operated to rotate in the valve opening direction beyond the fully-opened position, the fully-opened side stopper portion is mechanically engaged with a fully-opened side stopper member (i.e., a screw for adjusting a maximum fully-opened opening degree) screwed in a block-shaped fully-opened side stopper integrally formed with the valve housing 3. Thus, when the fully-opened side stopper portion of the final reduction gear 23 contacts the fully-opened side stopper or the fully-opened side stopper member, the rotating operation of the movable member (i.e., the rotatable member) such as the valve shaft 1, the butterfly valve 2 and the final reduction gear 23 in the valve opening direction is limited.

Spring inner-diameter guides 46, 47 on which the coil spring 12 is wound are formed in the valve housing 3 and the final reduction gear 23. One end portion of the coil spring 12 in the rotational axis line direction is engaged with a spring hook of the valve housing 3, and the other end portion of the coil spring 12 in the rotational axis line direction is engaged with a spring hook of the final reduction gear 23.

The motor for driving the butterfly valve 2 is configured to be energizing controlled (driven) by the ECU through the valve shaft 1. The ECU includes a microcomputer having a commonly-known structure, which is constituted by functions such as a CPU that performs control processing and arithmetic processing, a memory device that stores various programs, control logic and various data (for example, a memory such as a ROM and a RAM), an input circuit (i.e., an input portion), an output circuit (i.e., an output portion), a power supply circuit, and a timer.

The ECU is configured such that, when an ignition switch is turned on (i.e., IG·ON), engine control (for example, EGR control that controls the valve opening degree of the EGRV in accordance with the condition of the engine operation) is performed based on the control program or the control logic stored in the memory,

The ECU is configured such that, when the ignition switch is turned off (i.e., IG·OFF), the engine control based on the control program or the control logic stored in the memory is forcibly terminated.

In addition, in the engine shutdown, the engine control may be terminated with the butterfly valve 2 being maintained in a state of the intermediate opening degree (i.e., the intermediate position) in which the butterfly valve 2 is slightly opened from the fully-closed position in the valve opening direction by using the driving force of the motor of the EGRV or biasing force of the coil spring 12 or the like.

The microcomputer is connected to a crank angle sensor, an accelerator opening sensor, the valve opening degree sensor, an air flow meter, an intake air temperature sensor, a coolant temperature sensor and the like. Sensor signals from various sensors are A/D converted by an A/D converter, and then, the converted signals are inputted into the microcomputer embedded in the ECU.

The valve opening degree sensor is a noncontact rotational-angle detection device including two magnets 51 configured by permanent magnets which stably continue to generate magnetism for a long period, a hall IC 52 having a noncontact magnetic detection element which detects magnetic flux emitted from the magnets 51, and a separate stator core (e.g., magnetic material) 53 which converges the magnetic flux emitted from the magnets 51 on the hall IC 52. The valve opening degree sensor is configured to detect the rotational angle of the butterfly valve 2 (i.e., the valve opening degree of the EGRV) by using an output change property of the hall IC 52 with respect to a rotational angle of the magnets 51. That is, the valve opening degree sensor detects the valve opening degree of the EGRV based on a magnetic flux detection gap formed between opposed portions of the separate stator core 53, i.e., the change of a magnetic flux density passing through the hall IC 52.

The two magnets 51 are fixed to the other end portion of the valve shaft 1 in the rotational axis line direction, specifically, to the inner peripheral portion of the final reduction gear 23. Instead of the magnets 51, an electromagnet that generates magnetism in response to supply of electric power may be used.

The hall IC 52 is placed in the magnetic flux detection gap formed between the opposed portions of the separate stator core 53, which is formed in the sensor cover 11 by molding. Instead of the hall IC 52, the noncontact magnetic detection element such as a single hall element and a magnetoresistive element.

The sensor cover 11 covers an opening portion outside the valve housing 3, and forms a connector housing 55 that holds a coil terminal line of the motor and multiple terminals 54 that are electrically connected to sensor leads of the hall IC 52.

The valve housing 3 is made of, for example, a die-casting of heat resisting aluminum alloy, a casting of an aluminum alloy system, or heat resisting material (for example, a casting of an iron system, casting iron) which is excellent in heat resistance, and is formed to have a predetermined shape. The valve housing 3 is a device that openably and closably (rotatably) holds the butterfly valve 2 in a rotation direction from the fully-closed position to the fully-opened position in the exhaust-gas recirculation passages 13 to 15 each having a circular cross section. The valve housing 3 is fastened and fixed to exhaust-gas recirculation pipes (that is, the exhaust pipe and the intake pipe), which are arranged in front of and behind the exhaust-gas recirculation passages 13 to 15 by using fastening bolts.

The valve housing 3 includes a cylindrical EGR gas pipe portion (i.e., a first pipe portion) 61 having therein the exhaust-gas recirculation passage (i.e., a first fluid flow passage) 13, and a cylindrical EGR gas pipe portion (i.e., a second pipe portion) 62 having therein the exhaust-gas recirculation passages (i.e., second and third fluid flow passages) 14, 15. A passage diameter (i.e., an opening area) of the first pipe portion 61 is smaller than that of the second pipe portion 62. Thus, a circular ring-shaped stepped portion 63 is formed between the first and second pipe portions 61, 62.

The valve housing 3 has therein the first and second through-holes 16, 17 into which the valve shaft 1 is inserted. The first and second through-holes 16, 17 penetrate an outer wall portion (i.e., a block) of the valve housing 3 in the rotational axis line direction of the valve shaft 1. An opening portion of the first through-hole 16 formed in the valve housing 3 is air-tightly closed by a plug 64.

A bearing member such as the bushing 26, which pivotally (rotatably) supports the first sliding portion 21 of the valve shaft 1, is fitted and supported by the wall surface of the first through-hole 16 of the valve housing 3. Furthermore, a bearing member such as the oil seal 27 and the ball bearing 29, which pivotally (rotatably) supports the second sliding portion 22 of the valve shaft 1, is fitted and supported by the wall surface of the second through-hole 17 of the valve housing 3.

A first coupling surface attached to the exhaust-gas recirculation pipe at a side of the exhaust passage (i.e., a branch portion of the exhaust pipe of the engine, especially, a branch portion of the exhaust manifold) is arranged at the upstream side of the first and second through-holes 16, 17 of the valve housing 3 in the EGR gas flow direction. An inlet port for introducing the EGR gas into the exhaust-gas recirculation passages 13 to 15 from the exhaust passage is opened in the first coupling surface.

A second coupling surface attached to the exhaust-gas recirculation pipe at a side of the intake passage (i.e., a junction portion of the intake pipe of the engine, especially, a junction portion of the intake manifold) is arranged at the downstream side of the first and second through-holes 16, 17 of the valve housing 3 in the EGR gas flow direction. An outlet port for discharging the EGR gas into the the intake passage from the exhaust-gas recirculation passages 13 to 15 is opened in the second coupling surface.

Moreover, a circular ring-shaped stepped portion 65 is formed in the valve housing 3 at a side of the exhaust-gas recirculation passage 14. The sealing member 6 is sandwiched between the plate spring 5 and the stepped portion 65. An inner diameter of the stepped portion 65 is larger than a maximum outer-diameter portion of the seat ring 4. The stepped portion 65 contacts the sealing member 6. However, if the sealing member 6 is not arranged, the stepped portion 65 contacts the plate spring 5. Alternatively, the plate spring 5 is arranged to be opposed to the stepped portion 65 with a space interposed therebetween.

A cylindrical press-fit portion (i.e., a press-fit surface) 66 is formed on a flow passage surface of the second pipe portion 62 of the valve housing 3 so that an outer peripheral portion of the plate spring 5 is press-fitted in the second pipe portion 62.

Furthermore, an actuator case that forms a gear housing, in which the coil spring 12 and the gear reduction mechanism such as the motor gear, the intermediate reduction gear and the final reduction gear 23 are housed, is integrally formed with the valve housing 3. The actuator case is located between the outer wall portion of the valve housing 3 and the sensor cover H.

The seat ring 4 is made of, for example, stainless steel or heat resisting steel, which is excellent in heat resistance and abrasion resistance, synthetic resin such as wholly aromatic polyimide resin, or polytetrafluoroethylene (PTFE) containing carbon, and is formed to have a cylindrical shape. The seat ring 4 has therein the exhaust-gas recirculation passage 14, which is communicated with the combustion chamber in each cylinder of the engine and communicates between the exhaust-gas recirculation passage 13 and the exhaust-gas recirculation passage 15. That is, the seat ring 4 is a nozzle having a circular truncated cone shape (or a cylindrical shape), which is arranged to surround the circumference of the exhaust-gas recirculation passage 14 that configures a part of the fluid flow passage, in the circumferential direction.

The seat ring 4 is arranged in the valve housing 3 so as to be capable of moving to the upstream side and the downstream side of the flow direction of the EGR gas that flows through the exhaust-gas recirculation passages 13 to 15.

The seat ring 4 has the thick portion 34 having a circular truncated cone shape, which is arranged at a side of the axial direction portion 30 of the valve shaft 1 (i.e., at the upstream side of the EGR gas flow direction), and the thin portion (i.e., a cylinder portion, a nozzle) 35 having a cylindrical shape, which is arranged at an opposite side of the axial direction portion 30 of the valve shaft 1 (i.e., at the downstream side of the EGR gas flow direction). The thin portion 35 is thinner than the thick portion 34.

An inner peripheral portion of the seat ring 4, specifically, an inner peripheral surface of the thick portion 34 corresponds to the seat surface (i.e., a valve seat portion, a valve seat surface, an inner peripheral seat surface) 42 to which the contact surface 41 of the butterfly valve 2 is firmly attached when the butterfly valve 2 is in the fully-closed state.

A first opening portion (i.e., an inlet portion of the exhaust-gas recirculation passage 14) is formed at an end of the upstream side of the seat surface 42 in the EGR gas flow direction. The first opening portion has an opening area such that an outer peripheral portion of the large-diameter side edge surface 43 of the butterfly valve 2 firmly closes the first opening portion. A second opening portion (i.e., an outlet portion of the exhaust-gas recirculation passage 14) is formed at an end of the downstream side of the seat ring 42 in the EGR gas flow direction. The second opening portion has an opening area such that an outer peripheral portion of the small-diameter side edge surface 44 of the butterfly valve 2 firmly closes the second opening portion. The opening area of the second opening portion is smaller than that of the first opening portion.

The seat surface 42 is formed to have a concave curved surface so as to be fitted to the sphere-shaped contact surface 41 of the butterfly valve 2.

The upstream-side end surface of the seat ring 4, specifically, the upstream-side end surface of the thick portion 34 corresponds to the sliding part (i.e., a sliding surface) 36 that is brought into sliding contact with the cam portion 33, which is formed on a part of the axial direction portion 30 of the valve shaft 1 in the circumferential direction, when the butterfly valve 2 opens the exhaust-gas recirculation passages 13 to 15 at the first valve opening degree or more. The sliding part 36 is a sliding part between a valve shaft and a seat ring in two-step motion. The sliding part 36 is an opposed portion which is arranged to be opposed to the plane-surface portion 31, which is formed on a part of the axial direction portion 30 in the circumferential direction, with a predetermined gap therebetween when the butterfly valve 2 closes the exhaust-gas recirculation passages 13 to 15 at the second valve opening degree or less.

A cylindrical outer projection (i.e., a portion to be contacted) 68 is formed on an outer peripheral portion of the seat ring 4, specifically, an outer peripheral portion of the thick portion 34. The plate spring 5 is in elastically contact with the outer projection 68 through the sealing member 6. An outer diameter of the outer projection 68 is larger than that of the thin portion 35. A circular ring-shaped stepped portion 69 is formed between the outer projection 68 and the thin portion 35.

The plate spring 5 is made of metal material. In particular, the plate spring 5 is formed by pressing a circular ring-shaped metal plate (i.e., a metal thin plate) such as stainless steel or spring steel, for example. The plate spring 5 is arranged between the flow passage surface (i.e., the press-fit portion 66) of the valve housing 3 and the outer peripheral portion of the thick portion 34 (i.e., the outer projection 68) with the sealing member 6 sandwiched between the plate spring 5 and the outer projection 68. The plate spring 5 is an elastic member that generates elastic force (i.e., elastic repulsion force) to the seat ring 4 in a direction where the inner peripheral surface (i.e., the seat surface 42) of the thick portion 34 of the seat ring 4 is pushed to the contact surface 41 of the butterfly valve 2 (i.e., a radial direction of the seat ring 4 and in the EGR gas flow direction).

The plate spring 5 has a fitting portion 71 having a circular truncated cone shape (or a cylindrical shape), which is fixed to the flow passage surface of the valve housing 3, at an outer peripheral portion thereof. A press-fit surface is formed on an outer peripheral surface of the fitting portion 71 so that the outer peripheral surface of the fitting portion 71 is press-fitted in the press-fit portion 66 of the valve housing 3.

The plate spring 5 has an elastic holding portion 72 having a circular truncated cone shape at an inner peripheral portion thereof. The seat ring 4 is elastically held (i.e., floating-supported) in the radial direction thereof (i.e., a radial direction when a center axial line of the exhaust-gas recirculation passage 14 is used as the center, a radiation direction) and the center axial line direction of the exhaust-gas recirculation passage 14 (i.e., the EGR gas flow direction). A circular ring-shaped connection portion 73 for connecting the fitting portion 71 and the elastic holding portion 72 is formed between the fitting portion 71 and the elastic holding portion 72.

The elastic holding portion 72 is in elastically contact with an outer peripheral surface of the thick portion 34 of the seat ring 4 through the sealing member 6. The elastic holding portion 72 is formed by bending an end portion (i.e., an end portion at a side of the center axial line of the exhaust-gas recirculation passage 14) of the connection portion 73 to the downstream side of the EGR gas flow direction. An end portion (i.e., an end portion at the downstream side) 74 of the elastic holding portion 72 is bent to a side of the center axial line of the exhaust-gas recirculation passage 14. The connection portion 73 is formed by bending an end portion (i.e., an end portion at the upstream side) of the fitting portion 71 to the side of the center axial line of the exhaust-gas recirculation passage 14.

The plate spring 5 is sandwiched between the flow passage surface (Le., the press-fit portion 66) of the valve housing 3 and the outer peripheral portion of the thick portion 34 (i.e., the outer projection 68) so that the plate spring 5 is used with the elastic holding portion 72 compressed (Le., deformed) constantly.

The sealing member 6 is made of, for example, synthetic resin material such as polytetrafluoroethylene (PTFE) or synthetic rubber material such as fluorine-containing rubber or nitrile rubber (NBR), which is excellent in heat resistance. The sealing member 6 seals between an outer peripheral surface of the outer peripheral portion of the thick portion 34 (i.e., the outer projection 68) of the seat ring 4 and an inner peripheral surface of the elastic holding portion 72 of the plate spring 5.

The sealing member 6 has a circular ring-shaped flange 75, which is sandwiched between the stepped portion 65 of the valve housing 3 and the connection portion 73 of the plate spring 5, at an outer peripheral portion thereof.

The sealing member 6 has an elastic sealing portion 76 having a circular truncated cone shape at an inner peripheral portion thereof. The elastic sealing portion 76 is sandwiched between the outer peripheral surface (i.e., a part of a tapered surface having a circular truncated cone shape or a sphere) of the outer peripheral portion of the thick portion 34 (i.e., the outer projection 68) of the seat ring 4 and the inner peripheral surface (i.e., a part of a tapered surface having a circular truncated cone shape or a sphere) of the elastic holding portion 72 of the plate spring 5.

The elastic sealing portion 76 seals between the outer peripheral surface of the outer peripheral portion of the thick portion 34 (i.e., the outer projection 68) of the seat ring 4 and the inner peripheral surface of the elastic holding portion 72 of the plate spring 5. An end portion (i.e., an end portion at the downstream side) 77 of the elastic sealing portion 76 is bent to the side of the center axial line of the exhaust-gas recirculation passage 14. The end portion 77 of the elastic sealing portion 76 has an inner diameter substantially same with that of the end portion 74 of the elastic holding portion 72.

If the sealing performance between the outer peripheral surface of the outer peripheral portion of the thick portion 34 (i.e., the outer projection 68) of the seat ring 4 and the inner peripheral surface of the elastic holding portion 72 of the plate spring 5 can be obtained sufficiently even when the sealing member 6 is not arranged between the seat ring 4 and the plate spring 5, the sealing member 6 may not be arranged.

Next, the function of the EGRV included in the exhaust-gas recirculation device of the present embodiment will be described with reference to FIGS. 1 to 4C.

In the case where the butterfly valve 2 of the EGRV is driven in the valve opening direction, firstly, the ECU calculates a desired value of control (i.e., a desired opening degree) set in accordance with operation condition (i.e., an operation state) of the engine. Then, the electric power is supplied to the motor, and the motor shaft of the motor is rotated in the valve opening direction, Thus, the driving force of the motor (i.e., the motor torque) is transmitted to the motor gear, the intermediate reduction gear and the final reduction gear 23. The valve shaft 1, to which the driving force of the motor is transmitted from the final reduction gear 23, is rotated by a predetermined rotational angle in the valve opening direction in accordance with rotating of the final reduction gear 23.

At this time, the butterfly valve 2 attached to the center portion of the plane-surface portion 31 of the valve shaft 1 rotates with the rotational axis line of the valve shaft 1 centered. Thus, the butterfly valve 2 whose contact surface 41 is firmly attached to the seat surface 42 of the seat ring 4, which is elastically held by the elastic holding portion 72 of the plate spring 5 through the elastic sealing portion 76 of the sealing member 6 (refer to FIGS. 1, 3, 4A), is separated from the seat surface 42 of the seat ring 4, and thereby the exhaust-gas recirculation passages 13 to 15, specifically, the exhaust-gas recirculation passage (a flow passage opening) 14, are opened.

Therefore, the butterfly valve 2 is controlled to have the valve opening degree corresponding to the desired value of control. Thus, the EGR gas, which is a part of the exhaust gas flowing out of the combustion chamber in each cylinder of the engine, is recirculated to the intake passage formed in the intake pipe from the exhaust passage formed in the exhaust pipe through the exhaust-gas recirculation passages 13 to 15 formed in the EGRV. That is, the EGR gas is mixed into intake air (i.e., clean air filtered by an air cleaner) supplied to the intake port and the combustion chamber in each cylinder of the engine.

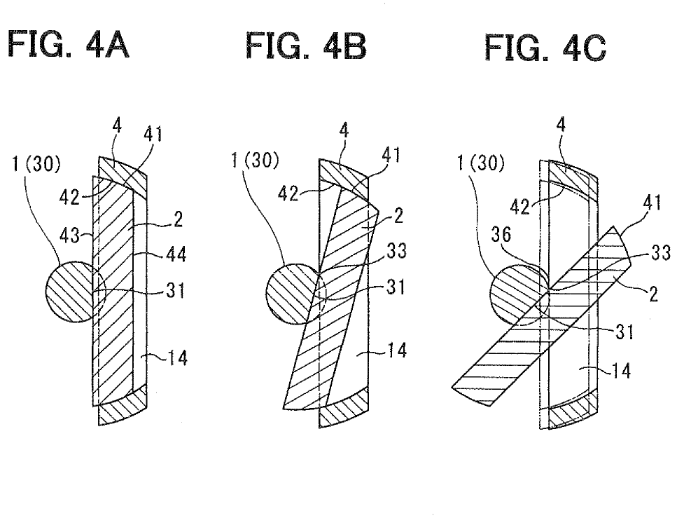

When the butterfly valve 2 opens the exhaust-gas recirculation passages 13 to 15 at the first valve opening degree in accordance with rotating of the valve shaft 1, the axial direction portion 30 of the valve shaft 1, which has been opposed to the sliding part 36 of the seat ring 4 with the predetermined gap therebetween, contacts the sliding part 36 of the seat ring 4, as shown in FIG. 4B. When the butterfly valve 2 opens the exhaust-gas recirculation passages 13 to 15 at the first valve opening degree or more in accordance with rotating of the valve shaft 1, the seat ring 4 moves as shown in FIG. 4C. The seat ring 4 is pushed to the location radially outward of the moving path (i.e., the rotating path) of the large-diameter side surface 43 of the butterfly valve 2 against the elastic force of the plate spring 5 (i.e., the elastic force which biases the seat surface 42 of the seat ring 4 toward the butterfly valve 2), while the cam portion 33, which is formed on a part of the axial direction portion 30 of the valve shaft 1 in the circumferential direction, is brought into sliding contact with the sliding part 36 of the seat ring 4.

When the butterfly valve 2 opens the exhaust-gas recirculation passages 13 to 15 to be at the fully-opened position (i.e., in the fully-opened state) in accordance with rotating of the valve shaft 1, the large-diameter side edge surface 43 and the small-diameter side edge surface 44 of the butterfly valve 2 are arranged along the flow direction of the EGR gas that flows through the exhaust-gas recirculation passages 13 to 15, as shown in FIG. 2. Thus, while the butterfly valve 2 opens the exhaust-gas recirculation passages 13 to 15 at the first valve opening degree or more, the cam portion 33 of the valve shaft 1 is brought into sliding contact with the sliding part 36 of the seat ring 4 without the sliding contact between the butterfly valve 2 and the seat ring 4. Unlike the related art, the worn position of the seat ring 4 of the present embodiment is a position different from the seat surface 42 (i.e., the sliding part 36).

In contrast, in the case where the butterfly valve 2 is operated to be in the fully-closed state from the state where the butterfly valve 2 opens the exhaust-gas recirculation passages 13 to 15 at the first valve opening degree or more, supply of electric power to the motor is stopped or limited. Thus, the butterfly valve 2 is returned to the fully-closed position by biasing force of the coil spring 12 (i.e., a spring load).

At this time, if the opening degree of the butterfly valve 2 is the second valve opening degree or more, the cam portion 33, which is formed on a part of the axial direction portion 30 of the valve shaft 1 in the circumferential direction, is brought into sliding contact with the sliding part 36 of the seat ring 4, and thereby the state where the seat ring 4 is pushed to the location radially outward of the moving path (i.e., the rotating path) of the butterfly valve 2 is maintained.

When the butterfly valve 2 closes the exhaust-gas recirculation passages 13 to 15 at the second valve opening degree in accordance with rotating of the valve shaft 1, the sliding contact between the cam portion 33 of the valve shaft 1 and the sliding part 36 of the seat ring 4 is released and the cam portion 33 is separated from the sliding part 36 of the seat ring 4. At this time, the butterfly valve 2 is brought into sliding contact with a part of the seat surface 42 of the seat ring 4 in the circumferential direction, which is elastically held by the elastic holding portion 72 of the plate spring 5 through the elastic sealing portion 76 of the sealing member 6. Then, when the butterfly valve 2 is in the fully-closed state in accordance with rotating of the valve shaft 1, the contact surface 41 of the butterfly valve 2 is firmly attached to the seat surface 42 of the seat ring 4 (refer to FIGS. 1, 3, 4A).

Thus, the contact surface 41 of the butterfly valve 2 and the seat surface 42 of the seat ring 4 are firmly sealed. Therefore, the leak of the EGR gas when the butterfly valve 2 fully closes the exhaust-gas recirculation passages 13 to 15 (i.e., when the butterfly valve 2 is in the fully-closed state) is absolutely prevented, and the EGR gas is not mixed into the intake air.

As described above, the exhaust-gas recirculation device of the present embodiment includes the EGR gas flow-amount control valve (i.e., the EGRV), in which the rotational axis line (i.e., the rotational axis) of the valve shaft 1 is decentered to the downstream side or the upstream side of the EGR gas flow direction by a predetermined distance from the center position of the butterfly valve 2 (i.e., the valve center). The contact surface 41 of the butterfly valve 2, which is fixed to and supported at the plane-surface portion 31 of the axial direction portion 30 of the valve shaft 1 by welding, is configured by a part of a sphere.

The plate spring 5 is arranged inside the valve housing 3 of the EGRV. The plate spring 5 is sandwiched between the flow passage surface (i.e., the press-fit portion 66) of the valve housing 3 and the outer peripheral portion of the thick portion 34 (i.e., the outer projection 68) of the seat ring 4 so that the plate spring 5 is used with the elastic holding portion 72 compressed (i.e., deformed) constantly. The plate spring 5 has the elastic holding portion 72, which is arranged between the flow passage surface (i.e., the press-fit portion 66) of the valve housing 3 and the outer peripheral portion of the thick portion 34 (i.e., the outer projection 68) of the seat ring 4 with the sealing member 6 sandwiched between the plate spring 5 and the outer projection 68. The elastic holding portion 72 generates elastic force to the seat ring 4 in the direction where the inner peripheral surface (i.e., the seat surface 42) of the thick portion 34 of the seat ring 4 is pushed to the contact surface 41 of the butterfly valve 2 (i.e., the radial direction of the seat ring 4 and in the EGR gas flow direction). That is, the seat ring 4 is elastically held inside the valve housing 3 through the plate spring 5 and the sealing member 6 in the radial direction thereof and in the EGR gas flow direction.

The axial direction portion 30 of the valve shaft 1 has the plane-surface portion 31 cut to be a planar shape and the cam portion 33 having a circular convex curved surface. The plane-surface portion 31 and the cam portion 33 are arranged adjacent to each other in the circumferential direction of the valve shaft 1. The EGRV is configured such that when the opening degree of the butterfly valve 2 is less than the first valve opening degree, or the second valve opening degree or less, the plane-surface portion 31 of the valve shaft 1 is arranged to be opposed to the sliding part 36 of the seat ring 4 with a predetermined gap therebetween in the EGR gas flow direction. The EGRV is configured such that when the opening degree of the butterfly valve 2 is the first valve opening degree or more, or more than the second valve opening degree, the cam portion 33 of the valve shaft 1 is brought into sliding contact with the sliding part 36 of the seat ring 4 to push the seat ring 4 to the location radially outward of the moving path (i.e., the rotating path) of the butterfly valve 2 against elastic force of the plate spring 5.

Thus, when the butterfly valve 2 opens the exhaust-gas recirculation passages 13 to 15 at the first valve opening degree or more, that is, the valve opening degree of the EGRV is the first valve opening degree or more, if the butterfly valve 2 is not brought into sliding contact with the seat ring 4, occurrence of uneven wear on the seat surface 42 of the seat ring 4 can be suppressed. Therefore, increasing of the amount of leaking EGR gas and decreasing of sealing performance when the butterfly valve 2 is in the fully-closed state, that is, the contact surface 41 of the butterfly valve 2 and the seat surface 42 of the seat ring 4 are firmly sealed can be limited.

When the butterfly valve 2 is in the fully-closed state, the seat surface 42 of the seat ring 4, which is always elastically held by the elastic holding portion 72 of the plate spring 5 through the elastic sealing portion 76 of the sealing member 6, is firmly attached to the contact surface 41 of the butterfly valve 2. Thus, the high sealing performance can be maintained between the contact surface 41 of the butterfly valve 2 and the seat surface 42 of the seat ring 4. That is, by elastically holding the seat ring 4 by the elastic holding portion 72 of the plate spring 5, the sealing performance between the contact surface 41 of the butterfly valve 2 and the seat surface 42 of the seat ring 4 when the butterfly valve 2 is in the fully-closed state can be improved.

When the butterfly valve 2 opens the exhaust-gas recirculation passages 13 to 15 at the first valve opening degree or more in accordance with rotating of the valve shaft 1, the seat ring 4 moves to be separated from the butterfly valve 2 against the elastic force of the elastic holding portion 72 of the plate spring 5 through the elastic sealing portion 76 of the sealing member 6 (that is, the seat ring 4 is pushed to the location radially outward of the moving path by the cam portion 33), and thereby, the butterfly valve 2 fixed to the valve shaft 1 can rotate smoothly. Thus, sliding torque between the butterfly valve 2 and the seat ring 4 when the butterfly valve 2 opens the exhaust-gas recirculation passages 13 to 15 at the first valve opening degree or more can be decreased.

Therefore, improving of the sealing performance between the contact surface 41 of the butterfly valve 2 and the seat surface 42 of the seat ring 4 when the butterfly valve 2 is in the fully-closed state, and decreasing of the sliding torque between the butterfly valve 2 and the seat ring 4 when the butterfly valve 2 opens the exhaust-gas recirculation passages 13 to 15 can be obtained.

Furthermore, the elastic sealing portion 76 of the sealing member 6, which seals between the outer peripheral surface (i.e., the tapered surface having a circular truncated cone shape) of the thick portion 34 of the seat ring 4 and the inner peripheral surface (i.e., the tapered surface having a circular truncated cone shape) of the elastic holding portion 72 of the plate spring 5, is sandwiched between the outer peripheral surface of the thick portion 34 of the seat ring 4 and the inner peripheral surface of the elastic holding portion 72 of the plate spring 5. Therefore, position fluctuation in the radial direction of the seat ring 4 (or in the EGR gas flow direction) and the motion of the seat ring 4 (i.e., the motion when the seat ring 4 is pushed by the cam portion 33 in the EGR gas flow direction) can be suppressed. Therefore, increasing of the amount of leaking EGR gas and decreasing of sealing performance when the butterfly valve 2 is in the fully-closed state (i.e., when the contact surface 41 of the butterfly valve 2 and the seat surface 42 of the seat ring 4 are firmly sealed) can be limited.

Elastic material such as synthetic rubber or natural rubber used as the elastic member for the seat ring 4 (i.e., an O-ring or packing) provides the sealing performance with pressure by which the compression of the elastic material is restored. However, if the elastic material is used for a long time, a part thereof may be permanently deformed (i.e., permanent set), and thereby decreasing the sealing performance. It is to be noted that the permanent set is deformation that remains even after the force that causes the compression deformation is removed completely.

By forming the plate spring 5 with metal material, for example, a circular ring-shaped metal plate (i.e., a plate spring) such as stainless steel or spring steel, the sealing performance between the contact surface 41 of the butterfly valve 2 and the seat surface 42 of the seat ring 4 can be maintained constantly with respect to changes over time, and thus, deterioration of the plate spring 5 can be limited.

Surface treatment or coating may be performed on the sliding part 36 that is a part of the seat ring 4 so as to improve sliding resistance or abrasion resistance. Compared to the case where surface treatment or coating is performed on the sliding part between the valve and the seat ring in the related art, for example, by performing surface treatment or coating on the part of the seat ring 4, a coated area or the amount of coating of a surface preparation agent such as molybdenum disulfide or a coating agent such as fluorine resin (PTFE) can be decreased, and thereby reducing cost.

Furthermore, surface treatment or coating is performed on the cam portion 33 that is a part of the valve shaft 1 so as to improve sliding resistance or abrasion resistance. Compared to the case where surface treatment or coating is performed on the sliding part between the valve and the seat ring in the related art, for example, by performing surface treatment or coating on the part of the valve shaft 1, a coated area or the amount of coating of a surface preparation agent such as molybdenum disulfide or a coating agent such as fluorine resin (PTFE) can be decreased, and thereby reducing cost.

### Second Embodiment

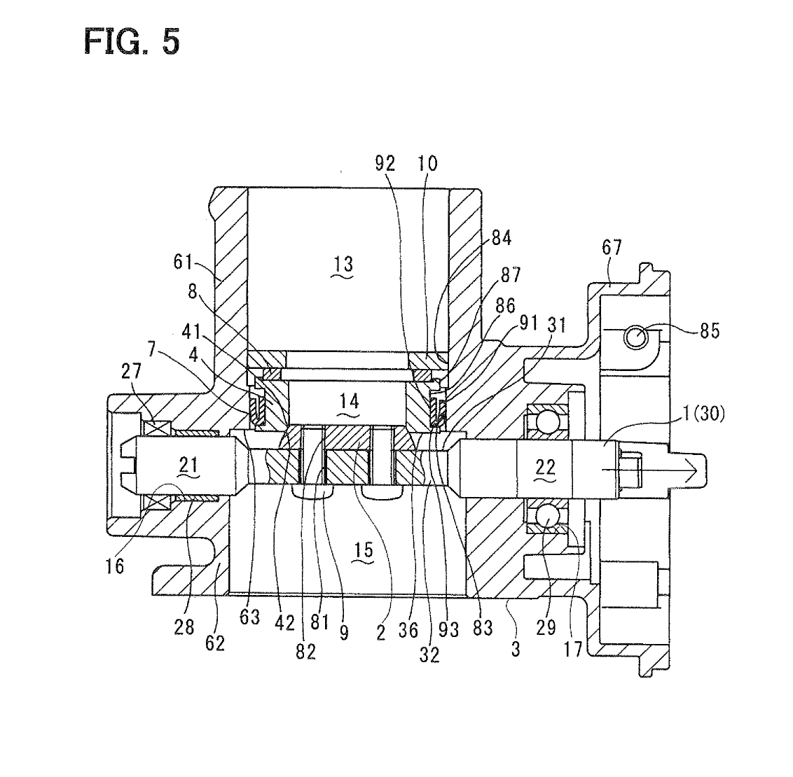

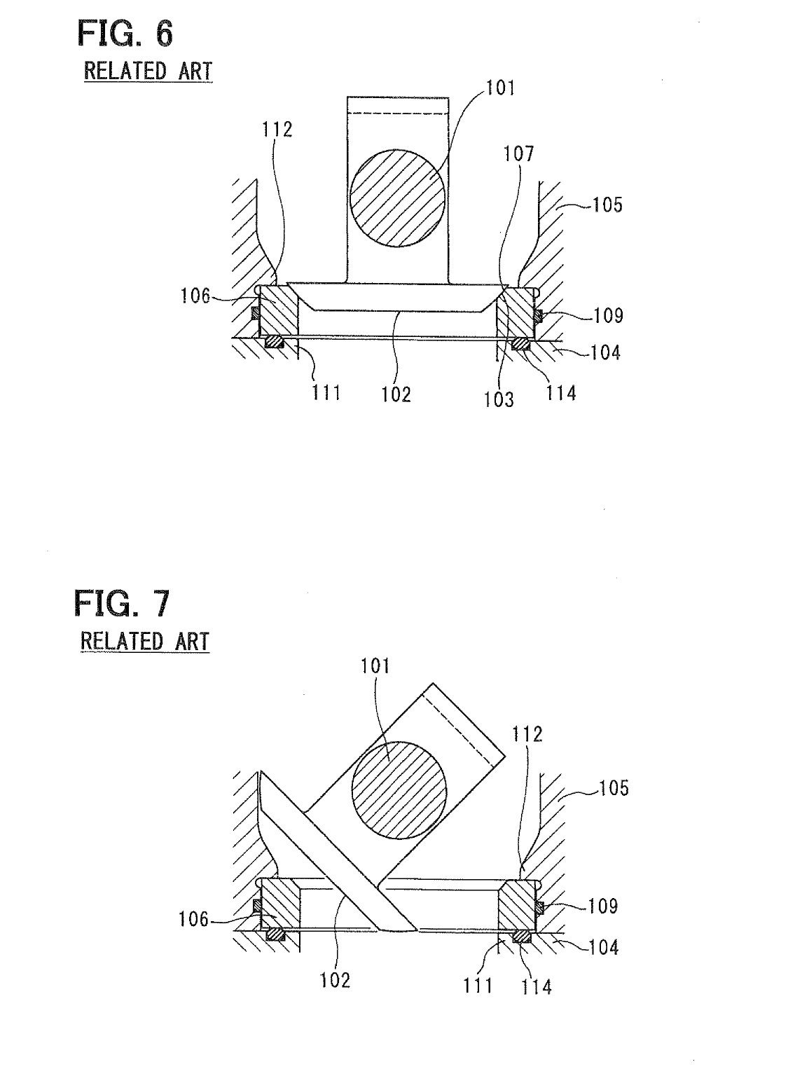

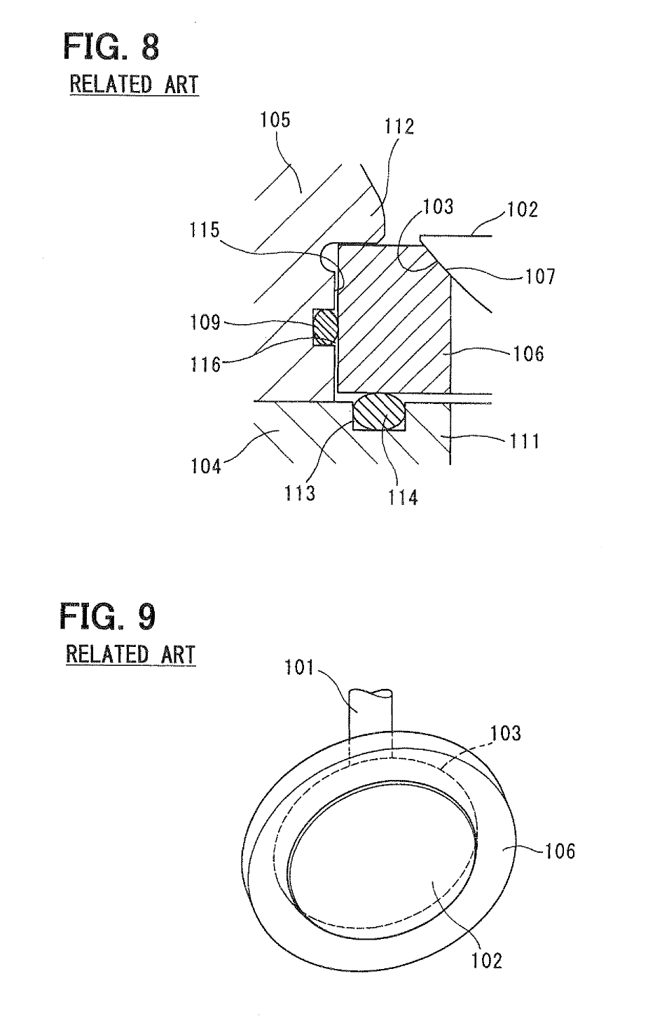

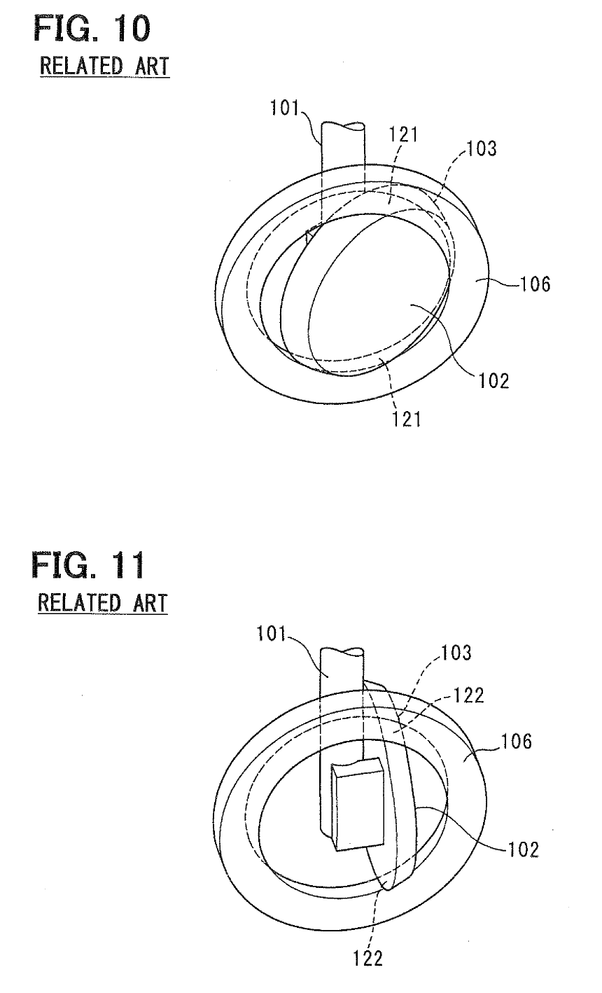

The second embodiment of the present invention is shown in FIG. 5. FIG. 5 is a view showing a main part of an EGR gas flow-amount control valve (Le., an EGRV).

An exhaust-gas recirculation device of the present embodiment includes the EGR gas flow-amount control valve (i.e., the EGRV), in which a rotational axis line (i.e., a rotational axis) of a valve shaft 1 is decentered to a downstream side or an upstream side of an EGR gas flow direction by a predetermined distance from a center position of a butterfly valve 2 (i.e., a valve center).

The EGRV of the present embodiment includes the valve shaft 1, the butterfly valve 2 having a circular plate shape, in which a contact surface 41 is configured by a part of a sphere, an electric actuator that drives the butterfly valve 2, a valve opening degree sensor that detects a valve opening degree of the EGRV, and a metal valve housing 3 which rotatably supports the valve shaft 1 and rotatably (openably and closably) houses the butterfly valve 2, and a sensor cover for covering an opening portion of an actuator case 67 of the valve housing 3.

The valve shaft 1 is rotatably supported in the valve housing 3 of the present embodiment. The butterfly valve 2 is openably and closably (rotatably) housed in the valve housing 3. Moreover, a seat ring 4 having a seat surface 42, to which the contact surface 41 of the butterfly valve 2 is firmly attached when the butterfly valve 2 is in a fully-closed state, is placed inside the valve housing 3. The seat ring 4 is elastically held (i.e., floating-supported) by the valve housing 3 through a lip seal (i.e., an elastic member) 7 made of synthetic rubber and a wave washer (Le., an elastic member) 8 made of metal in the EGR gas flow direction or a radial direction thereof.

A first sliding portion 21 of the valve shaft 1 is pivotally (rotatably) supported by a wall surface of a first though-hole 16 of the valve housing 3 through a bearing 28. A second sliding portion 22 of the valve shaft 1 is pivotally (rotatably) supported by a wall surface of a second though-hole 17 of the valve housing 3 through a ball bearing 29. An axial direction portion 30 of the valve shaft 1, which is formed between the first sliding portion 21 and the second sliding portion 22, has two plane-surface portions 31, 32 and a cam portion 33. Two predetermined parts of the valve shaft 1 in the circumferential direction are cut to be planar shapes so that the plane-surface portions 31, 32 are formed. Another part of the valve shaft 1 in the circumferential direction is formed to have the same diameter (i.e., outer diameter) with a maximum outer-diameter portion of the axial direction portion 30 so that the cam portion 33 is formed. The cam portion 33 may be arranged between the plane-surface portions 31, 32.

The axial direction portion 30 of the valve shaft 1 has two insertion holes 81 that communicate between the two plane-surface portions 31, 32. The butterfly valve 2 has two screw holes 82 configured to be communicated with the two insertion holes 81, respectively. The butterfly valve 2 is fastened and fixed to the plane-surface portion 31 of the axial direction portion 30 of the valve shaft 1 by using screws 9 such as fastening screws. The screws 9 penetrate the two insertion holes 81 from a side of the plane-surface portion 32, and are screwed in the two screw holes 82.

In the present embodiment, the insertion holes 81 are formed in the valve shaft 1, and the screw holes 82 are formed in the butterfly valve 82. However, screw holes in which the screws 9 are screwed may be formed in the valve shaft 1, and insertion holes may be formed in the butterfly valve 2.

The arrow shown in FIG. 5 is an insertion direction of the valve shaft 1 with respect to the first and second though-holes 16, 17 formed in the valve housing 3 when the valve shaft 1 is fixed to the valve housing 3. After the valve shaft 1 is fixed to the valve housing 3, the butterfly valve 2 is fixed to the valve shaft 1.

The valve housing 3 includes a cylindrical first pipe portion 61 having therein exhaust-gas recirculation passages 13, 14, and a cylindrical second pipe portion 62 having therein an exhaust-gas recirculation passage 15. A circular ring-shaped stepped portion 63 is formed between the first and second pipe portions 61, 62.

A cylindrical holding portion (i.e., an attaching portion) 83 and a cylindrical press-fit portion 84 are formed on a flow passage surface of the first pipe portion 61. The holding portion 83 elastically holds an outer peripheral portion of the lip seal 7. A C-ring for preventing the wave washer 8 from being removed or a securing ring 10 such as a snap ring is press-fitted in the press-fit portion 84.

The outer wall portion of the valve housing 3 (i.e., the actuator case 67) has a block-shaped fully-closed side stopper or a block-shaped fully-opened side stopper. A fully-closed side stopper member (i.e., a screw for adjusting a maximum fully-closed opening degree) or a fully-opened side stopper member (Le., a screw for adjusting a maximum fully-opened opening degree) 85 is screwed in the fully-closed side stopper or the fully-opened side stopper.

The seat ring 4 is made of, for example, stainless steel or heat resisting steel, which is excellent in heat resistance and abrasion resistance, synthetic resin such as wholly aromatic polyimide resin, or polytetrafluoroethylene (PTFE) containing carbon, and is formed to have a cylindrical shape. The seat ring 4 has therein the exhaust-gas recirculation passage 14, which is communicated with the combustion chamber in each cylinder of the engine and communicates between the exhaust-gas recirculation passage 13 and the exhaust-gas recirculation passage 15. That is, the seat ring 4 is a cylindrical nozzle, which is arranged to surround the circumference of the exhaust-gas recirculation passage 14 that configures a part of the fluid flow passage, in the circumferential direction.

The seat ring 4 is arranged in the valve housing 3 so as to be capable of moving to the upstream side and the downstream side of the flow direction of the EGR gas that flows through the exhaust-gas recirculation passages 13 to 15. Moreover, the seat ring 4 has the seat surface 42, to which the contact surface 41 of the butterfly valve 2 is firmly attached when the butterfly valve 2 is in the fully-closed state, on an inner peripheral portion thereof.

The downstream-side end surface of the seat ring 4 has a sliding part (i.e., a sliding surface) 36 that is brought into sliding contact with the cam portion 33, which is formed on a part of the axial direction portion 30 of the valve shaft 1 in the circumferential direction, when the butterfly valve 2 opens the exhaust-gas recirculation passages 13 to 15 at the first valve opening degree or more. The sliding part 36 is an opposed portion which is arranged to be opposed to the plane-surface portion 31, which is formed on a part of the axial direction portion 30 of the valve shaft 1 in the circumferential direction, with a predetermined gap therebetween when the butterfly valve 2 closes the exhaust-gas recirculation passages 13 to 15 at the second valve opening degree or less.

The seat ring 4 has a circular ring-shaped outer peripheral groove (i.e., a groove formed in the circumferential direction) 86 on an outer peripheral portion of the seat ring 4. The lip seal 4 is housed in the outer peripheral groove 86. The seat ring 4 has a circular ring-shaped fitting projection 87 for holding the wave washer 8 at an end surface thereof, which is opposite from the side of the valve shaft 1.

The lip seal 7 is made of, for example, synthetic rubber material such as fluorine-containing rubber or nitrile rubber (NBR), which is excellent in heat resistance and abrasion resistance, and is formed to have a bicylindrical shape. The lip seal 7 is a first elastic member that generates elastic force (i.e., elastic repulsion force) to the seat ring 4 in a direction where the seat surface 42 of the seat ring 4 is pushed to the contact surface 41 of the butterfly valve 2 (i.e., inwardly in a radial direction of the seat ring 4).

The lip seal 7 has a cylindrical rubber lip 91 that is press-fitted in the holding portion 83 of the valve housing 3 on an outer peripheral portion thereof. The rubber lip 91 is in elastically contact with the holding portion 83 of the valve housing 3.

The lip seal 7 has a cylindrical rubber lip (i.e., an elastic holding portion) 92 on an inner peripheral portion thereof. The seat ring 4 is elastically held (i.e., floating-supported) by the rubber lip 92 in the radial direction thereof (i.e., a radial direction when a center axial line of the exhaust-gas recirculation passage 14 is used as the center, a radiation direction). The rubber lip 92 is in elastically contact with an outer peripheral surface of the seat ring 4.

A circular ring-shaped connection portion 93 is formed between the rubber lips 91, 92 so as to connect an end portion of the rubber lip 91 to an end portion of the rubber lip 92 at the side of the valve shaft 1.

The lip seal 7 is sandwiched between the holding portion 83 of the valve housing 3 and the outer peripheral portion of the seat ring 4 so that the lip seal 7 is used with the rubber lips 91, 92 compressed (i.e., deformed) constantly.

The wave washer 8 is made of metal material. In particular, the wave washer 8 is formed by pressing a circular ring-shaped metal plate (i.e,, a metal thin plate) such as stainless steel or spring steel, for example. The wave washer 8 is a circular ring-shaped elastic body, which is deformable in the EGR gas flow direction perpendicular to the rotational axis line direction of the valve shaft 1 and is formed to have a wave shape in the circumferential direction. The wave washer 8 is sandwiched between an end surface of the seat ring 4 at the upstream side (i.e., an end surface at an opposite side from the sliding part 36) and the securing ring 10 with compressed in the EGR gas flow direction.

The wave washer 8 is a second elastic member that generates elastic force (i.e., pressurizing force, or elastic repulsion force) to the seat ring 4 in a direction where the seat surface 42 of the seat ring 4 is pushed to the contact surface 41 of the butterfly valve 2 (i.e., in the EGR gas flow direction). That is, the wave washer 8 as a whole constitutes the elastic holding portion so that the seat ring 4 is elastically held (i.e., floating-supported) in the EGR gas flow direction by the wave washer 8.

The securing ring 10 is fitted and supported by the press-fit portion 84 formed on the flow passage surface of the valve housing 3. The securing ring 10 prevents the wave washer 8 from being separated (i.e., being removed) from the seat ring 4.

As described above, in the EGRV of the present embodiment, rubber lips 91, 92 and the connection portion 93 seal between the flow passage surface of the valve housing 3 and the outer peripheral surface of the seat ring 4. Thus, even if rubber elastic force (i.e., elastic repulsion force) of the lip seal 7 is decreased after a long period of the use of the EGRV, the sealing performance between the flow passage surface of the valve housing 3 and the outer peripheral surface of the seat ring 4 can be secured by self-sealing effect due to the lip shape.

Since the lip seal 7 and the wave washer 8 are biased in the direction where the seat surface 42 of the of the seat ring 4 is pushed to the contact surface 41 of the butterfly valve 2, the seat surface 42 of the seat ring 4 is firmly attached to the contact surface 41 of the butterfly valve 2 when the butterfly valve 2 is in the fully-closed state. Thus, the high sealing performance can be kept between the contact surface 41 of the butterfly valve 2 and the seat surface 42 of the seat ring 4. That is, by elastically holding the seat ring 4 inside the valve housing 3 by the elastic force of the lip seal 7 and the wave washer 8, the sealing performance between the contact surface 41 of the butterfly valve 2 and the seat surface 42 of the seat ring 4 when the butterfly valve 2 is in the fully-closed state can be improved.

### Modified Embodiments

In the above embodiments, the electric actuator (i.e., a valve driving device) that drives the butterfly valve 2 through the valve shaft 1 is configured by an electric actuator including a motor and a power-transmitting mechanism (for example, the gear reduction mechanism). However, an electric actuator that drives a valve through a shaft may be configured by a negative-pressure operated actuator including an electromagnetic or electric negative-pressure control valve, or an electromagnetic actuator including an electromagnet having a coil.

Furthermore, the coil spring (i.e., the valve biasing means) 12 that biases the butterfly valve 2 of the EGRV in the valve closing direction or the valve opening direction may not be arranged. In this case, the number of components or assembling steps can be reduced. In the above embodiments, a housing having therein a fluid passage is configured by the valve housing 3 arranged in an EGR gas pipe. However, a housing may be configured by a housing defining a part of the intake pipe or a part of the exhaust pipe.

In the above embodiments, the fluid control valve of the present invention is applied to the EGRV that controls the flow amount of the exhaust gas (i.e., the EGR gas, the fluid). However, the fluid control valve may be applied to an exhaust-gas control valve that controls a temperature of the exhaust gas. Moreover, the fluid control valve may be applied to an air amount control valve such as a throttle valve, which controls the amount of intake air drawn into a combustion chamber of an internal combustion engine, an exhaust gas flow-amount control valve which controls the flow amount of the exhaust gas discharged from the combustion chamber of the engine, or an air flow-amount control valve such as an idle-speed control valve, which controls the amount of intake air that bypasses the throttle valve.

In the above embodiments, the fluid control valve of the present invention is applied to a fluid flow-amount control valve such as the EGRV. However, the fluid control valve is not limited to such a fluid flow-amount control valve, and may be applied to a fluid passage on-off valve, a fluid passage switching valve or a fluid-pressure control valve. Moreover, the fluid control valve may be applied to an intake air flow control valve such as a tumble flow control valve or a swirl flow control valve, an intake air variable valve that changes a passage length of the intake passage or a cross-sectional area of the passage. Furthermore, as an internal combustion engine (e.g., an engine for running) mounted to the vehicle, a gasoline engine may be used other than the diesel engine.

In the above embodiments, the EGRV is configured such that when the butterfly valve 2 opens the exhaust-gas recirculation passages 13 to 15 at the first valve opening degree or more from the fully-closed state, the cam portion 33 of the valve shaft 1 contacts the sliding part 36 of the seat ring 4. However, the EGRV may be configured such that just before or immediately after the butterfly valve 2 opens the exhaust-gas recirculation passages 13 to 15 at the first valve opening degree or more from the fully-closed state, the cam portion 33 of the valve shaft 1 contacts the sliding part 36 of the seat ring 4. The EGRV may be configured such that immediately after the butterfly valve 2 opens the exhaust-gas recirculation passages 13 to 15 from the fully-closed state, the cam portion 33 of the valve shaft 1 contacts the sliding part 36 of the seat ring 4. Furthermore, the EGRV may be configured such that just before the butterfly valve 2 is in the fully-opened state, the cam portion 33 of the valve shaft 1 contacts the sliding part 36 of the seat ring 4. That is, timing of when the butterfly valve 2 and the seat ring 4 are separated from each other may be arbitrary set except for the fully-closed state and the fully-opened state.

In the above embodiments, the plane-surface portion (i.e., the plane-surface cut portion) 31 formed on the outer peripheral portion of the valve shaft 1 is attached to the one end surface of the butterfly valve 2 in the thickness direction (i.e., the large-diameter side edge surface 43) b_{y} laser welding. However, TIG welding, MIG welding, electron beam welding, or arc welding may be performed in place of laser welding.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A fluid control valve comprising:
a housing defining therein a fluid passage and having a seat ring and an elastic member;
a valve housed in the housing, the valve being configured to open and close the fluid passage; and
a shaft to which the valve is fixed, rotatably supported in the housing, the shaft having a cam portion, wherein
a rotational axis line of the shaft is decentered from a center position of the valve,
the seat ring is configured to move in a flow direction of a fluid flowing through the fluid passage and the elastic member elastically holds the seat ring,
the seat ring has a sealing portion to which the valve is firmly attached when the valve fully closes the fluid passage, and
the cam portion is configured to be brought into sliding contact with the seat ring and push the seat ring to a location radially outward of a moving path of a large-diameter side edge surface of the valve against elastic force of the elastic member when the valve opens the fluid passage at a predetermined opening degree or more.

2. The fluid control valve according to claim 1, wherein
the elastic member generates the elastic force to the seat ring in a direction where the seat ring is pushed to the valve.

3. The fluid control valve according to claim 1, wherein
the valve has a contact surface configured by a part of a sphere.

4. The fluid control valve according to claim 1, wherein
a part of the shaft is cut to be a planar shape in a circumferential direction of the shaft.

5. The fluid control valve according to claim 1, wherein
when the valve closes the fluid passage at the predetermined opening degree or less, the sliding contact between the cam portion and the seat ring is released and the cam portion is separated from the seat ring.

6. The fluid control valve according to claim 1, wherein
the elastic member is made of a metal material.

7. The fluid control valve according to claim 1, wherein
the elastic member is made of a rubber material.

8. The fluid control valve according to claim 1, wherein
the elastic member is placed between an inner surface of the fluid passage and an outer peripheral surface of the seat ring.

9. The fluid control valve according to claim 1, wherein
the elastic member has an elastic holding member, which is brought into sliding contact with an outer peripheral surface of the seat ring and elastically holds the seat ring, and
a sealing member is sandwiched between the outer peripheral surface of the seat ring and the elastic holding member to seal between the outer peripheral surface of the seat ring and the elastic holding member.

10. The fluid control valve according to claim 1, wherein
the seat ring is a nozzle placed to surround a circumference of a communication passage configuring a part of the fluid passage in a circumferential direction of the communication passage, and
the elastic member has an elastic holding member placed to surround a circumference of the nozzle in the circumferential direction.

11. The fluid control valve according to claim 1, wherein
the seat ring has a sliding part configured to be brought into sliding contact with the cam portion when the valve opens the fluid passage at the predetermined opening degree or more.

12. The fluid control valve according to claim 11, wherein
surface treatment or coating for improving sliding resistance or abrasion resistance is performed on the sliding part.

13. The fluid control valve according to claim 1, wherein
surface treatment or coating for improving sliding resistance or abrasion resistance is performed on the cam portion.
